(19) United States
(12) Patent Application Publication
(10) Pub. No.: US 2020/0239508 A1
(43) Pub. Date: Jul. 30, 2020

(54) Extraction of Lignin From Lignocellulosic Waste Material Using Pyridinium Ionic Liquid

(71) Applicants: Maliha Uroos, Lahore (PK); Azmat Mehmood Asim, Lahore (PK); Nawshad Muhammad, Lahore (PK)

(72) Inventors: Maliha Uroos, Lahore (PK); Azmat Mehmood Asim, Lahore (PK); Nawshad Muhammad, Lahore (PK)

(21) Appl. No.: 16/742,708

(22) Filed: Jan. 14, 2020

(30) Foreign Application Priority Data
Jan. 29, 2019 (PK) 50/2019

(51) Int. Cl. C07G 1/00; B01D 11/02; B01D 37/00; B01D 21/26

(52) U.S. Cl. CPC C07G 1/00; B01D 11/0288; B01D 21/262; B01D 37/00; B01D 11/0292

(57) ABSTRACT

An exemplary embodiment presents a method of lignin extraction from lignocellulosic biomass. Lignin is a rich and economical source of various valuable products. It is a platform chemical for renewable biofuels, composite materials, biofilms etc. Delignification of lignocellulosic biomass affords cellulose-rich material as an additional product that is already known for many applications like bioethanol and other chemicals. The method includes grinding the lignocellulosic biomass, mixing the dried lignocellulosic biomass powder with ionic liquid, stirring and heating of the mixture followed by solvent extraction of lignin from the mixture.

### BACKGROUND OF THE INVENTION

Lignocellulosic biomass is a ubiquitous material which has undergone extensive research for their effective usage. The major aim of this research is the generation of energy from this waste; besides this, a number of useful renewable chemicals having numerous applications in industry and daily life may also be obtained. The prominent products which may result from economical biomass sources are bioethanol, bio-gas, bio-hydrogen, hydroxymethylfurfural (HMF), levulinic acid (LA) etc. Lignin is a component of lignocellulosic biomass which can be used as a low-value heating fuel, binder and dispersant, etc. In addition to this, it is a source of value-added compounds, such as adhesives, polyurethane, polyesters, biofilms and biologically active polyphenols (aromatics) [U.S. Pat. No. 10,208,076 B2]. Lignin contains a variety of aromatic compounds, which are currently obtained from fossil fuels.

The valorization of lignocellulosic biomass for lignin production is, however, hindered by some grave barriers. The hardest challenging factor is the adamant nature of biomass polymeric molecules; thus their breakdown becomes a cumbersome process. The recalcitrance of biomass polymers is due to its highly complex structure where cellulose is captured in the network of hemicellulose and lignin. The multifaceted bonding in the complex needs to be broken to reach the unexposed cellulose. These bonds are multifunctional (for example ether bond, ester linkage, etc.) and render lignocellulosic matrix structurally rigid.

WO 2016/197233 describes the organosolv extraction of lignin from Aspen wood material. Wood biomass is treated with polar protic solvents; that is the water-ethanol mixture to remove extractives and then lignin in the second step.

WO2006132199 describes a method for separation of lignin derivative 1,1-diphenyl propane from a mixture of lignin derivatives using aqueous solvents and metal oxides.

The most common method of lignin extraction i.e. Kraft method is practicable and productive in many ways. However, high temperatures, lengthy procedure duration and environmentally harmful chemicals used in this method urge a need of developing eco-friendly strategies for biomass valorization.

In the past two decades, the employment of ionic liquids (ILs) in the field of biomass processing has been extensively studied. ILs are featured with fascinating characteristics among which the solvating ability of ILs is the most prominent. The solvent and catalytic abilities of ILs in the field of biomass processing have attracted the researchers to work for more viable, efficient, eco-friendly and cost-effective methods using ILs [U.S. Pat. No. 8,668,807 B2].

US 2013/0252285 A1 depicts the ionic liquid pretreatment of biomass followed by enzymatic hydrolysis for its effective cellulosic conversion. Their process altered the lignin structure to enhance the enzymatic accessibility towards the cellulosic component.

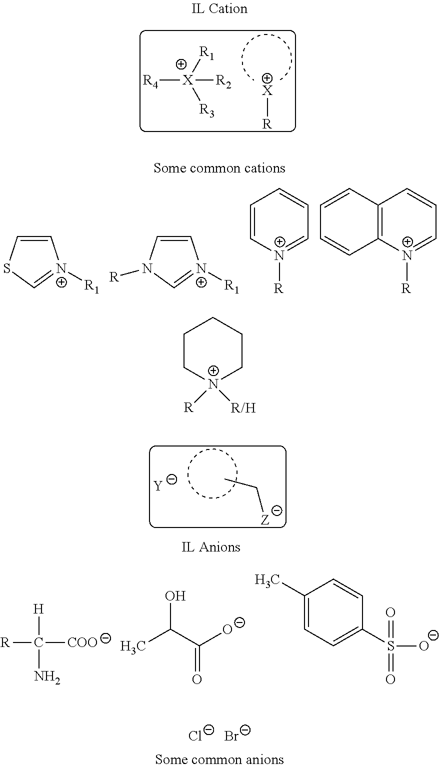

The most important aspiration is to use different ionic liquids to isolate the lignin. The present invention has identified acidic ionic liquids especially the protic ionic liquids (having acidic functionality either on cation or anion or both) as the best class of ionic liquids for the delignification of biomass. Cellulose and lignin components are dissolved first in protic ionic liquid and then fractionated using anti-solvents mixture; water and acetone. The significance of PILs lies in their facile synthesis and relatively mild conditions for biomass processing. The lignin obtained from pretreatment with PILs undergoes very little change in its structure, thus further processing for bio-refinery products from lignin is simple and efficient.

The study describes the use of protic acidic ionic liquids (PAILs) based on pyridinium cation and hydrogen sulfate anion (HSO₄⁻) or the clusters of HSO₄⁻ anion with H₂SO₄ (HSO₄⁻.xH₂SO₄ where x=0, 1, 3). In this study three protic ionic liquids based on pyridinium cation and HSO₄⁻ anion have been synthesized; pyridinium hydrogen sulfate [PyH][HSO₄] (IL1), pyridinium hydrogen sulfate mono sulfuric acid [PyH][HSO₄.(H₂SO₄)] (IL2), and pyridinium hydrogen sulfate trisulfuric acid [PyH][HSO₄.(H₂SO₄)₃] (IL3) and utilized for the process of extraction of lignin from lignocellulosic biomass.

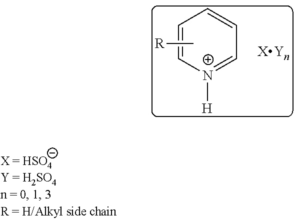

### BRIEF SUMMARY OF THE INVENTION

An exemplary embodiment provides a novel but simple method for the extraction of lignin from lignocellulosic biomass. A series of protic ionic liquids have been prepared using a very simple and short time strategy and applied for the extraction of lignin from lignocellulosic biomass. As a consequence of the pretreatment, appreciable amounts of biopolymer lignin have been achieved under mild conditions from short-time processing. The lignin thus extracted from inexpensive processes can be a platform of many valuable products. Starting from this material, the synthesis of phenolic compounds, biofuels, fibers, biofilms, and composites of various types can be achieved.

The extraction of lignin from lignocellulosic biomass has been successfully realized using a facile process. The method may be termed as a green method because the solvents employed for extraction are of negligible volatility and can be recycled after the extraction is accomplished. The protic ionic liquids dissolve the lignin component of the biomass leaving cellulose-rich material undissolved. Lignin can be isolated from the other fractions effortlessly. The advantage of the exemplary embodiment is that the process is green, and the undissolved components can also be isolated and utilized for various products. Other aspects of the embodiment will be presented in the following discussion or will be apparent from the disclosure or can be learned by practicing the inventory method.

The preceding discussion and the forthcoming description are exemplary and explanatory and are intended to furnish the detailed explanation of the claimed matter.

### BRIEF DESCRIPTION OF THE SEVERAL VIEWS OF THE DRAWING

The appended diagrams, which furnish extended apprehension of the concept of the invention and comprise the illustrative part of this specification; serve, in conjunction with the description, to elucidate principles of the inventive concept.

FIG. 1 elucidates a flow diagram of the process of extracting lignin from lignocellulosic biomass using protic ionic liquids according to the embodiment.

FIG. 2 is the composition of the original untreated wheat straw

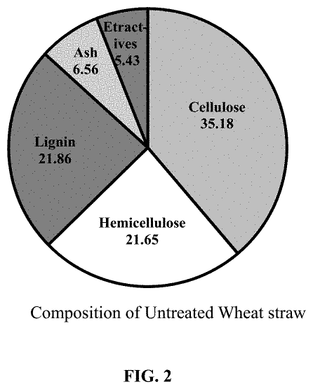

FIG. 3 describes the extent of lignin removal from the biomass by treatment with different ionic liquids (at 100° C. for IL1 and IL2 and at 60° C. for IL3) for 2 hours with mechanical stirring at a speed of 160 rpm; the biomass loading was 5% while the particle size of the ground biomass being 250 micrometer.

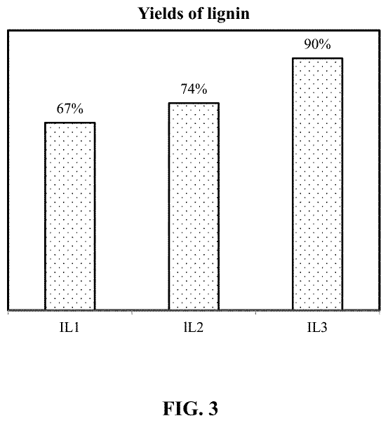

FIG. 4 exhibits a comparison of compositional analyses of original untreated wheat straw and pretreated wheat straw after lignin removal using three different ionic liquids IL1, IL2 and IL3 under the optimum conditions as described in [0016]. In the corresponding figure. ASL stands for acid soluble lignin and AIL for acid insoluble lignin.

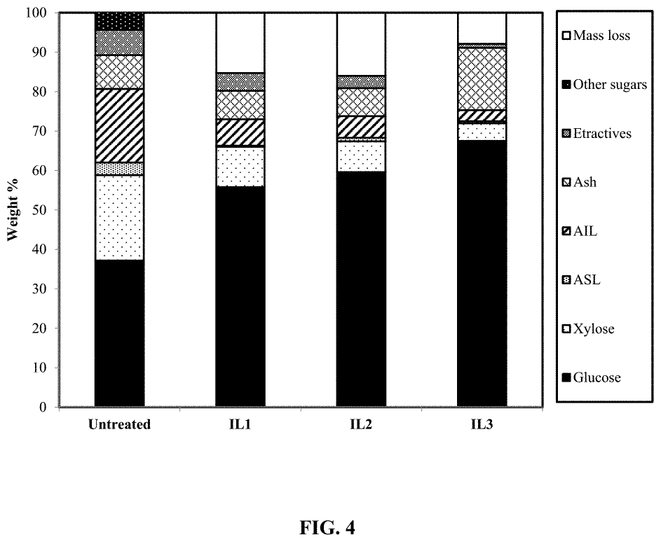

FIG. 5 elucidates the Fourier transform infrared (FT-IR) spectra of 5a) the original untreated lignocellulosic biomass 5b) ionic liquid-pretreated biomass sample 5c) lignin extracted from lignocellulosic biomass under optimum conditions as in [0016] and in accordance with an exemplary embodiment.

FIG. 6 is the thermogravimetric analysis of 6a) original untreated lignocellulosic biomass, 6b) cellulose-rich material obtained after pretreatment using ionic liquid under the optimum conditions as in [0016], 6c) lignin extracted from lignocellulosic biomass after pretreatment

FIG. 7 indicates Scanning Electron Microscopic images of 7a) the original untreated lignocellulosic biomass 7b) cellulose-rich material obtained after pretreatment in accordance with an exemplary embodiment.

### DETAILED DESCRIPTION OF THE INVENTION

The following illustration provides a detailed illustration of different aspects, which afford a systematic understanding of many exemplary embodiments. However, the exemplary embodiments can be practiced without the help of meticulously explained embodiments or with the help of a similar arrangement.

In this disclosure, the exemplary embodiments present a method for the extraction of lignin; a beneficial component of lignocellulosic biomass from waste or abundant natural resources. The exemplary embodiments present a process of extraction of lignin from lignocellulosic biomass using cost-effective solvents called ionic liquids. Being a ubiquitous and safe starting material, lignocellulosic biomass is an economical and renewable source of lignin. The extraction of lignin is accomplished using protic ionic liquids, a green class of solvents; thus, enabling the process to be environment friendly. In addition, the ionic liquids are recyclable and are regenerated after the completion of the lignin extraction process. Lignin is a useful material being a generous source of various products. It is used to produce phenolic compounds which, in turn, act as starting reagents for numerous industrially important products like heating fuels, adhesives, polyurethane, polyesters, biofilms and biologically active chemicals. Lignin may also be used to obtain carbon fibers, composite polymers and biofilms. The extraction method is carried out under very mild conditions of temperature within a short time thus the additional advantage that the basic structure of lignin remains intact under these conditions. The method produces no waste; as the lignin component is isolated and the residue left behind is cellulose-rich material (CRM). The usefulness and significance of CRM have already been extensively probed. It provides biofuels like bioethanol and other valuable products like 5-hydroxymethylfurfural (HMF), levulinic acid (LA), nanocrystalline cellulose etc. Therefore, the exemplary embodiments afford cost-effective, yield effective, time effective and eco-friendly processes of lignin extraction.

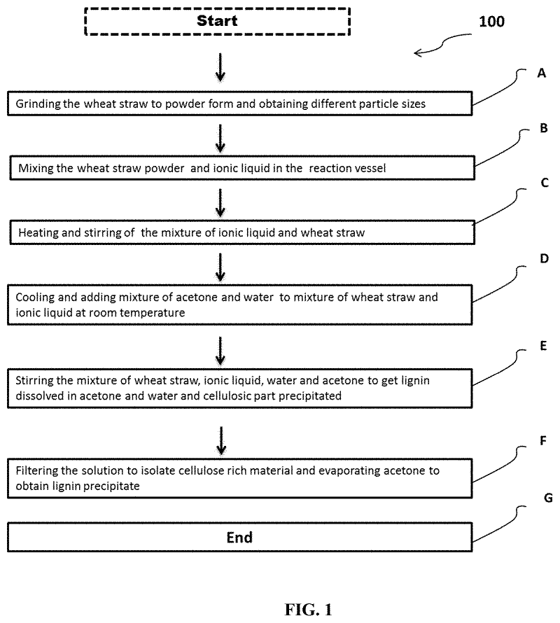

FIG. 1 illustrates the exemplary embodiment process of extraction of lignin from lignocellulosic biomass employing protic ionic liquids based on pyridinium cation and hydrogensulfate anion (HSO₄⁻) or the clusters of HSO₄⁻ anion with H₂SO₄ (HSO₄⁻.xH₂SO₄ where x=0, 1, 3). Lignocellulosic biomass was collected locally; the method begins at the start box (A).

Block A provides the method of grinding the lignocellulosic biomass to powder form. This may be achieved using a domestic grinder, shear mixture or commercial grinding machine. The required particle size of the lignocellulosic biomass powder may be obtained using mesh sieves. In the exemplary embodiments, the particle size of 100, 250 and 500 μm has been used.

In block B the method involves the mixing of lignocellulosic biomass powder of desired particle size with the ionic liquid. The ionic liquid may be added first in a reaction vial or flask or any other suitable container followed by lignocellulosic biomass. The lignocellulosic biomass powder is added to the reaction container where the ionic liquid may be in a pre-heated form.

Block C gives a method of heating and stirring the mixture of ionic liquid and the lignocellulosic biomass powder. The reaction mixture may be heated on a hot plate adjusted at the required temperature. The stirring may be carried out using a mechanical or magnetic stirrer at a slower speed (100-160 rpm) to avoid the splashing of the contents. The method involves placing the reaction mixture in an oil bath kept on a hot plate at the required temperature, heating the reaction contents for 30 min to 2 hours' time duration at 40 to 100° C. For example, the reaction vessel may be heated at 60° C. for 2 hours. For instance, the reaction mixture may be heated at 80° C. for 1 hour.

Block D provides a method of cooling the reaction mixture after switching off and adding the 1:1 mixture of acetone and water as an anti-solvent. The reaction vessel is removed after fix duration of time (e.g. 2 hours) at the desired temperature (e.g. 80° C.). It is then allowed to stay for cooling down to room temperature. Nine times of water-acetone mixture (1:1) are added to the cooled reaction mixture and it is again allowed to stir for half an hour for complete dissolution and separation of lignin.

Block E is a method of separation of cellulose-rich material (CRM) from the mixture by filtration. This step involves removing the reaction vessel from stirring and letting it stay for 15-30 min period to ensure complete precipitation of CRM. Cellulose rich material is then filtered off. The filtration may be accomplished using ordinary Whatmann filter paper of small pore size or vacuum filtration by the Buchner apparatus. The residue is washed multiple times first with the acetone-water mixture and then with excess water only.

Block F is a method of isolation of lignin from the filtrate obtained from E. Acetone is first evaporated from the mixture obtained from E at room temperature or at 40° C. As the acetone vaporizes dark brown lignin settles down. After ensuring complete evaporation of acetone the mixture is subjected to centrifugation at a rate of 3000 to 5000 rpm. The supernatant layer, which is a mixture of water and ionic liquid and other products, is decanted off to obtain solid lignin. Lignin is then washed multiple times with distilled water to get the purified product. The supernatant layer contains water and ionic liquid from which ionic liquid can be recycled by evaporating water. It may be used again for the whole process with minimum or no change inefficiency. The method may end at terminal block G.

Ionic Liquids are organic compounds in the salt form, which melt under ambient conditions. The salt contains an organic cation and an anion of organic or inorganic origin. In an exemplary embodiment, the ionic liquid may contain a protic pyridinium cation and hydrogen sulfate anion. In exemplary embodiments the ionic liquid may be one of pyridinium hydrogen sulfate (IL1), pyridinium hydrogen sulfate mono sulfuric acid (IL2) and pyridinium hydrogen sulfate trisulfuric acid (IL3).

### EXAMPLES

Examples 1-7 demonstrate various methods of extracting lignin from lignocellulosic biomass where only one factor is changed to optimize the process. Example 1 is the use of a similar method of extraction of lignin except that of three different ionic liquids i.e. pyridinium hydrogen sulfate (IL1), pyridinium hydrogen sulfate mono sulfuric acid (IL2) and pyridinium hydrogen sulfate trisulfuric acid (IL3) are used. Example 2 exhibits the method of extraction of lignin where the only temperature is varied keeping the other factors constant. Example 3 involves the method where varied time intervals for which the mixture of ionic liquid and lignocellulosic biomass powder are heated. In example 4 the speed, at which the mixture of ionic liquid and lignocellulosic biomass powder are stirred, is varied. Example 5 describes the change of the relative ratio of ionic liquid and biomass keeping the method and the other factors the same. Example 6 is the method of separation of lignin from lignocellulosic biomass having different particle sizes after the pretreatment with ionic liquid. Example 7 is the method of extraction of lignin from wheat straw where the biomass was treated with IL3 under optimum conditions.

### Example 1—Employment of Ionic Liquids Having Different Compositions

Lignocellulosic waste material (Lignocellulosic biomass) was collected and ground to powder using a grinder. The ionic liquid was charged in the reaction vessel kept at the desired temperature (40-100° C.). The ionic liquid may be one of pyridinium hydrogen sulfate, pyridinium hydrogen sulfate mono sulfuric acid and pyridinium hydrogen sulfate trisulfuric acid. The percent amount of lignocellulosic biomass that was charged into ionic liquid was 5%. The reaction mixture was stirred at 100 rpm for 1 hour time at 100° C. After switching off the reaction, the mixture was cooled down to room temperature and an equimolar mixture of acetone and water was added. This mixture was stirred for 30 minutes and then allowed to stay, while keeping the vessel closed, to precipitate the cellulosic rich part. After filtering off the cellulosic part the lignin was precipitated by evaporating acetone from the filtrate and collected by centrifugation.

### Example 2—Extraction of Lignin from Lignocellulosic Biomass

The lignocellulosic biomass sample, typically wheat straw, was ground to powder form and different particle sizes by mesh sieves were obtained. Ionic liquid (IL3) was charged to the vessel followed by 5% of the powder lignocellulosic biomass in various particle sizes 100 μm, 250 μm and 500 The method was carried out at a temperature between 40-100° C., for example, 60° C., for 2 hours. After the processing and cooling of mixture 1:1 acetone-water was added followed by 30 min stirring; the cellulose part settled down. The filtration removed the cellulose-rich component and acetone from the filtrate was evaporated to precipitate lignin. Lignin was isolated by centrifugation and the supernatant gave ionic liquid on evaporation of water. The composition of the pretreated wheat straw was determined by following the compositional analysis protocol established by NREL (NREL/TP-510-42618). The results of the compositional analysis are provided in Table 6.

### Example 3—Effect of Temperature on Lignin Extraction

Lignocellulosic waste material (Lignocellulosic biomass) was collected and ground to powder form followed by obtaining the desired particle size through a mesh sieve. The ionic liquid was charged to the vessel followed by 5% of the powder lignocellulosic biomass. The method was carried out at one of 40, 50, 60, 80, 100° C. for 1 hour. After processing and cooling of mixture 1:1 acetone-water mixture was added followed by 30 min stirring; the cellulose part settled down. The filtration removed the cellulose-rich component and acetone was evaporated from the filtrate to get precipitated lignin. Lignin was isolated by centrifugation where the supernatant layer gave ionic liquid on evaporation of water.

TABLE 1
** Effect of temperature on Lignin yield (%)

| Ionic | | | | | |
|---|---|---|---|---|---|
| Liquid | 40° C. | 50° C. | 60° C. | 80° C. | 100° C. |
| IL1 | 7 | 12 | 24 | 44 | 67 |
| IL2 | 11 | 13 | 27 | 45 | 74 |
| IL3^{α} | 24 | 56 | 90 | — | — |

** Biomass loading 5%, Particle size 250 microns and time of 2 h, 160 rpm
^{α}IL3 burnt the biomass at 80 and 100 °C

### Example 4—Effect of Time of Pretreatment on Lignin Extraction

After collecting lignocellulosic biomass it was ground to powder form then desired particle size was obtained by mesh sieve. The ionic liquid was charged to the vessel followed by 5% of the powder lignocellulosic biomass. The method was carried out at a temperature between 40-100° C. for 30 min to 2 hours. For example, ½ hour, 1 hour, 1.5 hours and 2 hours. After the processing and cooling of mixture 1:1 acetone-water was added followed by 30 min stirring; the cellulose part settled down. The filtration removed the cellulose-rich component and acetone from the filtrate was evaporated to precipitate lignin. Lignin was isolated by centrifugation and the supernatant gave ionic liquid on evaporation of water.

TABLE 2
** Effect of time of pretreatment on lignin extraction (%)

| | |
|---|---|
| Ionic | Time |

| Liquid | 30 min | 1 h | 1.5 h | 2 h |
|---|---|---|---|---|
| IL1 | 4 | 19 | 34 | 67^{γ} |
| IL2 | 7 | 23 | 41 | 74^{γ} |
| IL3 ^{α} | 12 | 39 | 73 | 90 |

** Biomass loading 5%, Particle size 250 microns, 160 rpm and temperature 100° C.,
^{α} for IL3 at 60° C.

### Example 5—Effect of the Speed of Rotation on Lignin Extraction

Lignocellulosic waste material (Lignocellulosic biomass) was ground to powder form and the desired particle size was obtained by mesh sieve. Ionic liquid, pyridinium hydrogen sulfate monosulfuric acid, was charged into the container and temperature adjusted as desired. The lignocellulosic biomass powder in 5% load was then added to the ionic liquid and the mixture was heated at the required temperature, for example, 80° C. for 1 hour, with mechanical stirring at speed of 100 rpm, 130 rpm and 160 rpm. After pretreatment the mixture was cooled down; 1:1 mixture of acetone and water (9 times the volume) was added and it was stirred for 30 min. The mixture was allowed to stay after switching off the magnetic stirring gave the cellulose-rich part as a precipitate. The cellulosic component was filtered off and the filtrate was subjected to slight heating to evaporate acetone as a result of which lignin settled down as brown solid. Lignin was then obtained by centrifugation and the supernatant was used to recycle the ionic liquid.

TABLE 3
** Effect of speed of rotation of mechanical
stirrer on lignin yield (%)

| Ionic | Speed of Rotation | | |
|---|---|---|---|
| Liquid | 100 rpm | 130 rpm | 160 rpm |
| IL1 | 51 | 58 | 67 ^{γ} |
| IL2 | 54 | 63 | 74 ^{γ} |
| IL3 ^{α} | 61 | 73 | 90 |

** Biomass loading 5%, Particle size 250 microns , time 2 h and temperature 100° C.
^{α} for IL3 at 60° C.

### Example 6—Effect of Biomass Loading on Lignin Extraction

Lignocellulosic waste material (Lignocellulosic biomass) was ground to powder form and the desired particle size was obtained by mesh sieve. Ionic liquid, pyridinium hydrogen sulfate trisulfuric acid, was charged into the container and temperature adjusted as desired. The lignocellulosic biomass powder in 5%, 10% and 15% load was then added to the ionic liquid and the mixture was heated at the required temperature, for example, 60° C., for a certain time (e.g. 1 hour). After pretreatment and cooling, 1:1 mixture of acetone and water (9 times the volume) was added and it was stirred for 30 min. The mixture, when allowed to stay after switching off the magnetic stirrer, gave the cellulose-rich part as a precipitate. The cellulosic component was filtered off and the filtrate was subjected to slight heating to evaporate acetone as a result of which lignin settled down as brown solid. Lignin was then obtained by centrifugation and the supernatant was used to recycle the ionic liquid.

TABLE 4
** Effect of biomass loading on Lignin Yield (%)

| Ionic | Biomass Loading | | |
|---|---|---|---|
| Liquid | 5% | 10% | 15% |
| IL1 | 67^{γ} | 58 | 51 |
| IL2 | 74^{γ} | 63 | 54 |
| IL3 ^{α} | 90 | 73 | 61 |

** Particle size 250 microns, time 2 h, 160 rpm and temperature 100° C.
^{α} for IL3 at 60° C.

### Example 7—Effect of Particle Size on Lignin Extraction

After collecting lignocellulosic biomass, it was ground to powder form and different particle sizes by mesh sieves were obtained. The ionic liquid was charged to the vessel followed by 5% of the powder lignocellulosic biomass in various particle sizes 100 μm, 250 μm and 500 The method was carried out at a temperature between 40-100° C., for example, 60° C., for 1 hour. After the processing and cooling of mixture 1:1 acetone-water was added followed by 30 min stirring; the cellulose part settled down. The filtration removed the cellulose-rich component and acetone from the filtrate was evaporated to precipitate lignin. Lignin was isolated by centrifugation and the supernatant gave ionic liquid on evaporation of water.

TABLE 5
** Effect of particle size on lignin yield (%)

| Ionic | Particle Size | | |
|---|---|---|---|
| Liquid | 100 μm | 250 μm | 500 μm |
| IL1 | 58^{γ} | 67 | 51 |
| IL2 | 63^{γ} | 74 | 54 |
| IL3 ^{α} | 73 | 90 | 61 |

** Biomass loading 5%, time 2 h, 160 rpm and temperature 100° C.
^{α} for IL3 at 60° C.

### Analysis

Characterization of the isolated cellulosic rich and lignin parts was conducted using various techniques. This led to confirm the appreciable removal of lignin from lignocellulosic biomass and the pure nature of extracted lignin. The cellulose and lignin samples were subjected to compositional analysis (HPLC, UV-VIS), Fourier transforms infrared spectroscopy (FTIR), thermogravimetric analysis (TGA), and scanning electron microscopy (SEM).

### Compositional Analysis

Compositional analysis was performed on both the untreated biomass and the delignified pulp according to the NREL protocol; “Determination of structural carbohydrates and lignin in biomass” (NREL/TP-510-42618). The results of the compositional analysis are provided in the following table (Table 6).

TABLE 6
**The composition of untreated wheat straw
and after pretreatment with different ILs

| Ionic | Glucose | Xylose | ASL | AIL | Ash | Extractives |
|---|---|---|---|---|---|---|
| Liquid | (%) | (%) | (%) | (%) | (%) | (%) |
| Untreated | 37.18 | 21.65 | 3.19 | 18.67 | 8.56 | 6.43 |
| IL1 | 55.8 | 10.2 | 0.3 | 6.7 | 7.2 | 4.5 |
| IL2 | 59.6 | 7.8 | 0.9 | 5.5 | 7.1 | 3.1 |
| IL3 ^{α} | 67.5 | 4.5 | 0.5 | 2.8 | 15.8 | 1.0 |

**Biomass loading 5%,, time 2 h, wheat straw particle size 250 μm, 160 rpm, temperature 100° C.
^{α} for IL3 at 60 C.,
ASL—Acid soluble lignin,
AIL—Acid insoluble lignin

### HPLC Analysis

HPLC analysis for sugar content analysis was performed using the Schimadzu system equipped with an Aminex HPX-87P column, a de-ashing column and a Carbo-P guard column. The column temperature was set at 80 C while the flow rate is 0.6 ml/min. Deionized water was used as the mobile phase.

### FT-IR Analysis

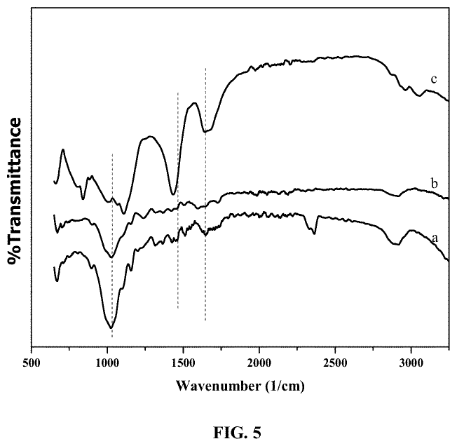

FT-IR analysis of the original lignocellulosic biomass, cellulosic rich material (CRM) and extracted lignin is given in FIG. 5. The peaks at 1430, 1371, 1318, 1162, 1119, 1025, and 897 cm⁻ are associated with cellulose. The peak at 897 cm⁻ is assigned to the glycosidic linkage (at C₁) and the peak at 1025 cm⁻ corresponds to the C-O-C stretching in glucopyranose ring. This peak is obvious in all the samples but in the case of biomass sample pretreated using IL3 (mole ratio 4:1) it is relatively weaker. The peak at about 1160 cm⁻ is attributed to C—O anti-symmetric stretching. The CH₂ symmetric bending is represented by the peak at 1430 cm⁻. The peak intensity of this band has reduced which is an indication of less crystalline cellulose in the IL-pretreated samples of biomass. The peak at 1319 cm⁻ is due to CH bending in carbohydrates and that at 1365 cm⁻ is for CH bending in cellulose. The peak at about 1513 cm⁻ is assigned to the aromatic ring conjugated bonds which is a characteristic of lignin. Apparently, this peak has significantly reduced intensity verifying appreciable removal of lignin from the biomass after pretreatment. A peak at 1650 cm⁻ is also characteristic of phenolic OH bonds in lignin. This peak has also been rendered weak in the pretreated biomass.

Referring to FIG. 5, the FT-IR spectrum of lignin fraction isolated after pretreatment with ionic liquid is given. The peaks pertaining to the lignin portion of lignocellulosic biomass, where they have weak intensity, are prominent in the lignin spectrum.

### Thermogravimetric Analysis

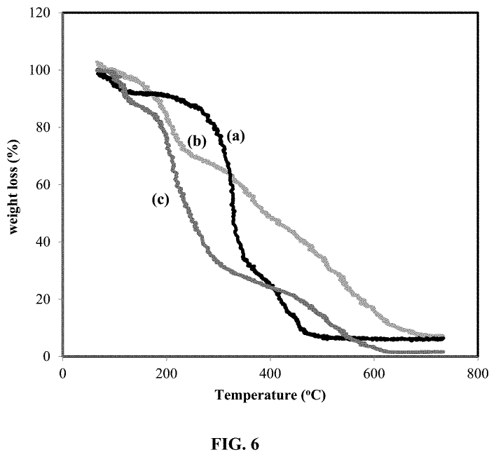

FIG. 6 refers to the thermogravimetric analysis of the original lignocellulosic biomass (6a) cellulosic rich material (CRM) after lignin removal under optimum conditions (6b) and isolated lignin (6c). Thermogravimetric analysis was conducted to assess the stability variation before and after pretreatment. The difference in the stability of the untreated and pretreated biomass samples verifies the effectiveness of pretreatment. Thermograph shows reduced stability of the pretreated biomass sample (6c). The stability of lignin is also less than that of original biomass (6b).

### Scanning Electron Microscopy

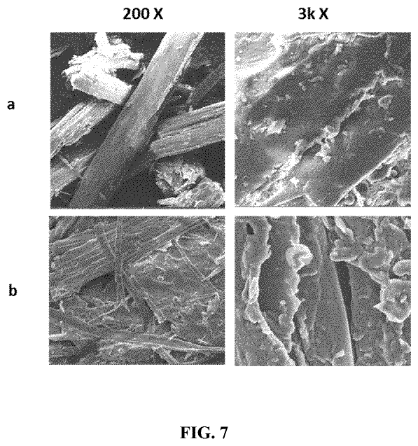

FIG. 7 refers to scanning electron microscopic analysis. The original biomass and regenerated CRM were subjected to scanning electron microscopy (SEM) to verify the effect of pretreatment on the morphology of the polymeric network of biomass. It was expected that the biomass structure would be disrupted as a consequence of pretreatment and removal of lignin. It is clear from the SEM images that the ILs used in this study have affected the morphological arrangement of biomass. The SEM image of untreated biomass (a) shows a flat structure that undergoes disruption when treated with the ILs (b).

Some exemplary incarnations have been described here still; others will be apparent from the demonstration. Similarly, the concept of the invention is not limited to the exemplary embodiments and bears broader scope and significance of the claims and modifications of arrangement may be done.

1. A method for extracting lignin from lignocellulosic biomass materials comprising:
a. selecting a biomass from a group of biomasses comprising rice straw, wheat straw, sugar cane bagasse, poplar, acacia wood, and pine wood;
b. grinding the biomass (step a) into a powder;
c. adding an ionic liquid to step (b);
d. heating step (c) with continuous stirring;
e. adding an acetone and water mixture (1:1 v/v) to step (d) to precipitate cellulose-rich component and dissolve lignin part in the biomass;
f. filtering step (e) to separate dissolved lignin in a solution from the precipitated cellulose-rich component;
g. evaporating acetone from the dissolved lignin solution (step f) to precipitate lignin;
h. centrifuging step (g) to remove separate lignin;
i. drying step (h) to obtain powder lignin.

2. The method of claim 1, wherein the ionic liquid comprises cations of pyridinium (with or without alkyl side chains) and hydrogen sulfate-based anions in the form of monomer, dimer and tetramer moieties.

3. The method of claim 1 where the lignocellulosic biomass is ground to particle sizes ranging between 125 and 500 μm, preferably, 250 μm.

4. Method of claim 1 wherein the lignocellulosic biomass added is not more than 15% (w/v) of the total mass.

5. The method of claim 4 where the lignocellulosic biomass preferably added is 5% of the ionic liquid (w/v).

6. The method of claim 1 wherein the mixture of ionic liquid and lignocellulosic biomass powder is heated to the temperature range of 40° C. to 100° C.

7. The method of claim 6 wherein the mixture of ionic liquid and lignocellulosic biomass powder is heated to 60° C. for 30 minutes to 2 hours.

8. The method of claim 1 wherein the continuous stirring is maintained at a speed range of 100-160 rpm.

9. The method of claim 1 wherein the mixture of ionic liquid and lignocellulosic biomass powder is heated and stirred under atmospheric pressure.
